(19) United States
(12) Patent Application Publication
(10) Pub. No.: US 2014/0071096 A1
(43) Pub. Date: Mar. 13, 2014

(54) STYLUS AND METHOD FOR DISPLAYING INPUTS OF THE STYLUS

(71) Applicant: FIH (HONG KONG) LIMITED, Kowloon (HK)

(72) Inventor: YU-LUN LI, Taoyuan (TW)

(73) Assignee: FIH (HONG KONG) LIMITED, Kowloon (HK)

(21) Appl. No.: 13/688,252

(22) Filed: Nov. 29, 2012

(30) Foreign Application Priority Data
Sep. 10, 2012 (TW) 101135014

(51) Int. Cl. G06F 3/0354

(52) U.S. Cl. CPC G06F 3/03545
USPC 345/179

(57) ABSTRACT

In a method to display a current input of a stylus, the method controls a communication unit to receive a notification signal notifying that a first input of the stylus is selected from a touch device. Then the method selects a second input of the stylus from the storage device, and the second input is the same as the first input. The method further sends the second input to a display unit, and displays the second input on the display unit.

### BACKGROUND

1. Technical Field

Embodiments of the present disclosure relate to a stylus and methods using the stylus, and more particularly to a stylus and a method for displaying an input of the stylus.

2. Description of related art

When a user uses a touch device, a stylus is often used as a writing tool, and the user selects a desired input on the touch device, wherein the input may be a color or a graphic of the stylus inputted on a touch device. However, the input of the stylus need to be set through an operation on the touch device, and then, the selected input is displayed on a touch screen to remind the user of the currently selected input, which occupies space of the touch screen of the touch device. In some prior arts, a currently selected input can be hidden from the touch screen in order to save the space of the touch screen of the touch device. However, the user needs to re-operate the touch device to check the current input, which may be inconvenient.

### BRIEF DESCRIPTION OF THE DRAWINGS

FIG. 1 is a block diagram of one embodiment of a stylus including an input displaying system.

FIG. 2 is a block diagram of one embodiment of function modules of the input displaying system in FIG. 1.

FIG. 3 is a flowchart of one embodiment of a method for displaying an input of the stylus of FIG. 1.

FIG. 4 is a flowchart of one embodiment of steps for adjusting the input of a stylus.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

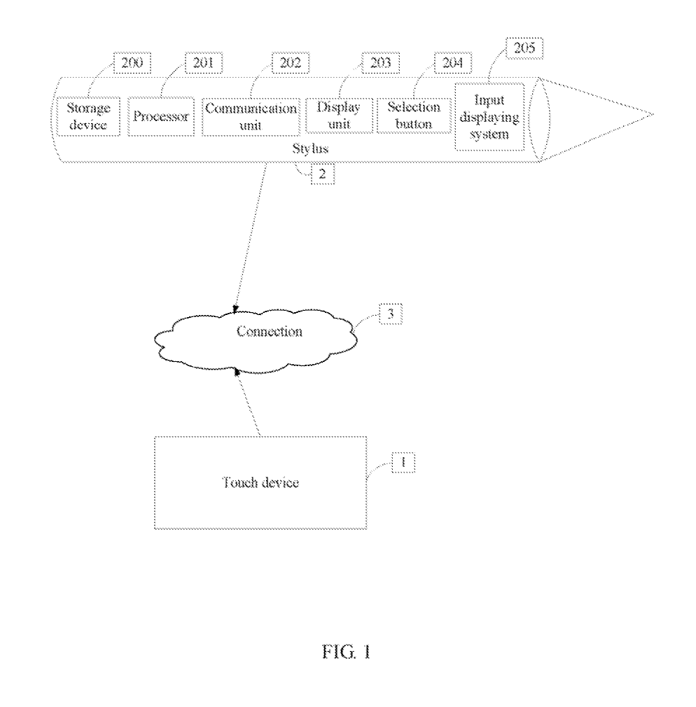

FIG. 1 is a block diagram of one embodiment of a stylus 2 including an input displaying system 205. In the embodiment, the stylus 2 communicates with a touch device 1 through a connection 3. The connection 3 may be a wired or a wireless connection.

The stylus 2 is an input tool that can be carried by the touch device 1. The touch device 1 may be a smart phone, a personal digital assistant, a graphics tablet, or a tablet personal computer. A user can use the stylus 2 to write or draw on the touch device 1. Using the stylus 2 can improve precision of the touch input and avoid getting natural oil from hands of the user on the touch device 1. The stylus 2 includes a storage device 200, a processor 201, a communication unit 202 and a display unit 203, and a selection button 204.

The storage device 200 may include any type(s) of non-transitory computer-readable storage medium, such as a hard disk drive, a compact disc, a digital video disc, or a tape drive. In the embodiment, the storage device 200 stores a plurality of inputs of the stylus 2, and the inputs displaying system 205. The plurality of inputs in the storage device 200 are the same as a plurality of inputs on the touch device 1. The plurality of inputs of the stylus 2 may be colors, graphics, or other contents inputted on the touch device 1 by the stylus 2.

The at least one processor 201 may include a processor unit, a microprocessor, an application-specific integrated circuit, and a field programmable gate array, for example.

The communication unit 202 communicates with the touch device 1 through the connection 3. In the embodiment, if the connection 3 is a wired connection, the communication unit 202 may be a USB interface, and the stylus 2 connects to the touch device 1 through USB data cable. If the connection 3 is a wireless connection, the communication unit 202 may be a wireless communication device.

The display unit 203 displays a currently selected input in a real-time, so that the user can further make a real-time adjustment of the input of the stylus 2 according to need.

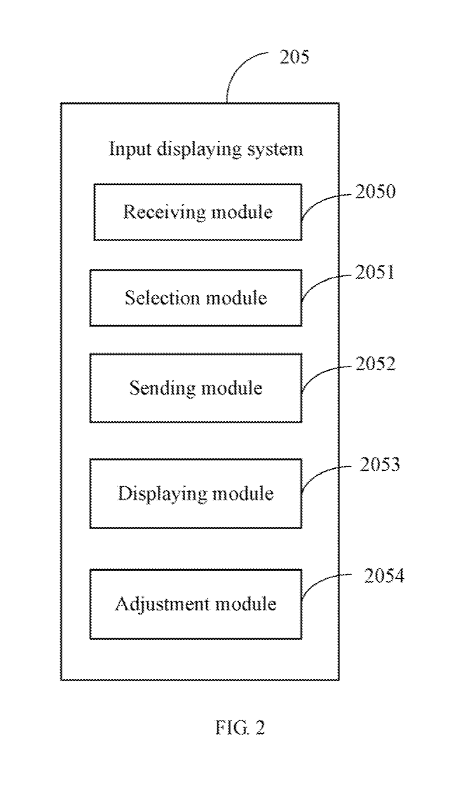

In one embodiment, the input displaying system 205 includes a plurality of function modules (see FIG. 2 below), which include computerized codes or instructions that can be stored in the storage device 220 and executed by the processor 201 to provide a method for displaying an input of the stylus 2.

When the selection button 204 is pressed, one input from the storage device 200 is selected. The selection button 204 can be pressed repeatedly until a desired input is selected.

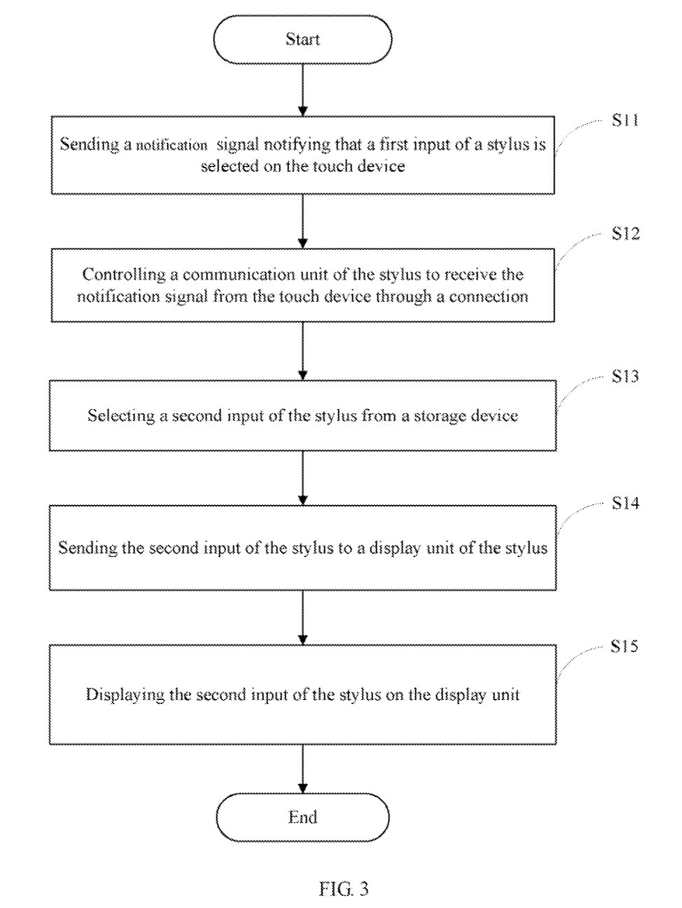

FIG. 2 is a block diagram of one embodiment of the input displaying system 205 included in the stylus 2. In one embodiment, the input displaying system 205 may include a receiving module 2050, a selection module 2051, a sending module 2052, a displaying module 2053, and further includes an setting module 2054. The modules may comprise computerized codes in the form of one or more programs that are stored in the storage device 200 and executed by the processor 201 to provide functions for implementing the modules. The functions of the function modules 2050-2054 are illustrated in FIG. 3 and described below.

FIG. 3 illustrates a flowchart of one embodiment of a method for displaying an input of the stylus 2. Depending on the embodiment, additional steps may be added, others removed, and the ordering of the steps may be changed.

In step S11, the touch device 1 sends a notification signal to the stylus 2, the notification signal notifies that a first input of the stylus 2 is selected from the touch device 1. The first input of the stylus 2 is selected on the touch device 1 by an operation of a user.

In step S12, the receiving module 2050 controls the communication unit 202 to receive the notification signal from the touch device 1 through the connection 3.

In step S13, the selection module 2051 selects a second input of the stylus 2 from the storage device 200. The second input of the stylus 2 is the same as the first input of the stylus 2.

In step S14, the sending module 2052 sends the second input of the stylus 2 to the display unit 203.

In step S15, the displaying module 2053 displays the second input of the stylus 2 on the display unit 203.

As described above, from the step S11 to the step S15, by means of displaying the currently selected input on the display unit 203 of the stylus 2 in real-time, the user can be reminded clearly of the currently selected input to decide whether to adjust the input of the stylus 2 according to need.

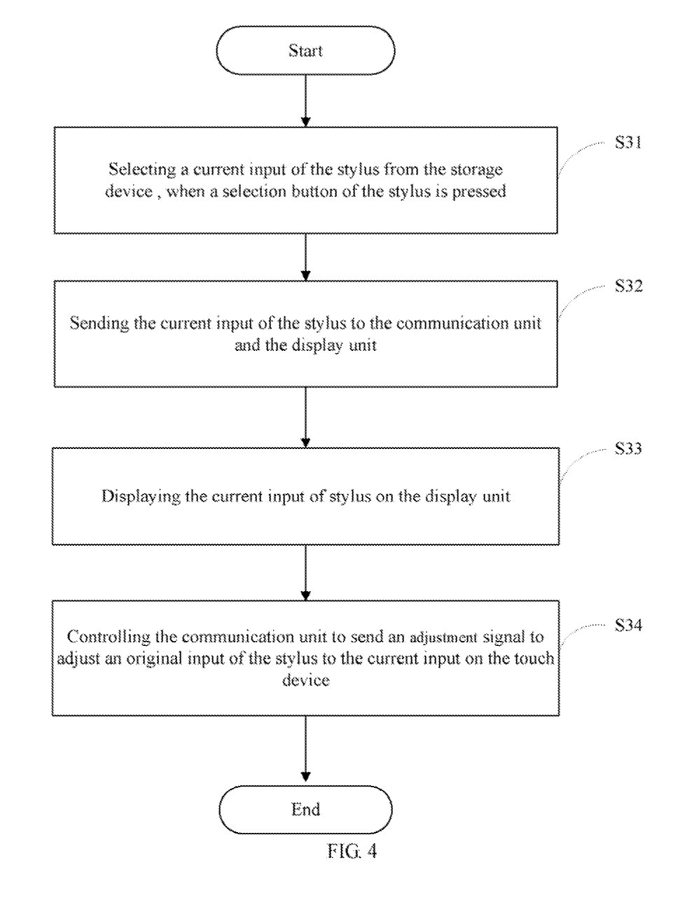

In the embodiment, the method for displaying a current input of the stylus 2 may further include a step of adjusting an input of the stylus 12. FIG. 4 illustrates a flowchart of one embodiment of a step of adjusting an input of the stylus 12. Depending on the embodiment, additional steps may be added, others removed, and the ordering of the steps may be changed.

In step S31, the selection module 2051 selects a current input of the stylus 12 from the storage device 200 when the selection button 204 is pressed. In the embodiment, the selection button 204 can be pressed repeatedly until a desired input of the stylus 12 is selected.

In step S32, the sending module 2052 sends the current input of the stylus 12 to the communication unit 202 and the display unit 203.

In step S33, the displaying module 2053 displays the current input of stylus 12 on the display unit 203.

In step S34, the adjustment module 2054 controls the communication unit 202 to send an adjustment signal to adjust an original input of the stylus to the current input on the touch device 1.

As described above, from the step S31 to the step S34, by means of adjusting the input on the stylus 2, the user can avoid inconveniences taken by operating the touch device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A stylus, comprising:
a communication unit;
a display unit;
a storage device;
at least one processor; and
one or more modules that are stored in the storage device and executed by the at least one processor, the one or more modules comprising:
a receiving module that controls the communication unit to receive a notification signal notifying that a first input of the stylus is selected on a touch device by a touch action of a user;
a selection module that selects a second input of the stylus from the storage device, wherein the second input of the stylus is the same as the first input of the stylus;
a sending module that sends the second input of the stylus to the display unit; and
a displaying module that displays the second input of the stylus on the display unit.

2. The stylus according to claim 1, further comprising a selection button.

3. The stylus according to claim 2, wherein the selection button is pressed repeatedly until a desired input of the stylus is selected.

4. The stylus according to claim 2, wherein:
the selection module further selects a current input of the stylus from the storage device when the selection button is pressed, and further sends the current input of the stylus to the communication unit and the display unit; and
the adjustment module sends an adjustment signal to adjust an original input of the stylus to the current input on the touch device.

5. The stylus according to claim 1, wherein the input of the stylus is presented by a color or graphic drawing.

6. A method for displaying a current input of a stylus, the method comprising:
controlling the communication unit to receive a notification signal notifying that a first input of the stylus is selected on a touch device by a touch action of a user;
selecting a second input of the stylus from a storage device of the stylus, wherein the second input of the stylus is the same as the first input of the stylus;
sending the second input of the stylus to a display unit of the stylus; and
displaying the second input of the stylus on the display unit.

7. The method according to claim 6, wherein the stylus comprises a selection button.

8. The method according to claim 7, wherein the selection button is pressed repeatedly until a desired input of the stylus is selected.

9. The method according to claim 7, further comprising:
selecting a current input of the stylus from the storage device when the selection button is pressed;
sending the current input of the stylus to the communication unit and the display unit; and
sending an adjustment signal to adjust an original input of the stylus to the current input of the stylus on the touch device.

10. The method according to claim 7, wherein the input of the stylus is presented by a color or graphic drawing.

11. A non-transitory computer-readable storage medium having stored thereon instructions capable of being executed by a processor of a stylus, causes the processor to perform a method for displaying a current input of the stylus, the method comprising:
controlling the communication unit to receive a notification signal notifying that a first input of the stylus is selected on a touch device by a touch action of a user;
selecting a second input of the stylus from a storage device of the stylus, wherein the second input of the stylus is the same as the first input of the stylus;
sending the second input of the stylus to a display unit of the stylus; and
displaying the second input of the stylus on the display unit.

12. The storage medium according to claim 11, wherein the stylus comprises a selection button.

13. The storage medium according to claim 12, wherein the selection button is pressed repeatedly until a desired input of the stylus is selected.

14. The storage medium according to claim 11, wherein the method further comprises:
selecting a current input from the storage device when the selection button is pressed;
sending the current input of the stylus to the communication unit and the display unit; and
sending an adjustment signal to adjust an original input of the stylus to the current input of the stylus on the touch device.

15. The storage medium according to claim 11, wherein the input of the stylus is presented by a color or graphic drawing.
